(19) United States
(12) Patent Application Publication
(10) Pub. No.: US 2020/0074377 A1
(43) Pub. Date: Mar. 5, 2020

(54) CONTRIBUTION LEVEL DETERMINATION METHOD, CONTRIBUTION LEVEL DETERMINATION APPARATUS, AND RECORDING MEDIUM

(71) Applicant: Panasonic Intellectual Property Corporation of America, Torrance, CA (US)

(72) Inventors: Toru TANIGAWA, Osaka (JP); Yukie SHODA, Osaka (JP); Junichi IMOTO, Osaka (JP); Yusuke TSUKAMOTO, Osaka (JP); Seiya IMOMOTO, Hyogo (JP)

(21) Appl. No.: 16/541,784

(22) Filed: Aug. 15, 2019

(30) Foreign Application Priority Data
Aug. 29, 2018 (JP) 2018-159825

(51) Int. Cl. G06Q 10/06; G06K 9/00; G06K 9/62; G06Q 50/00; G06Q 40/00

(52) U.S. Cl. CPC G06Q 10/06398; G06K 9/00369; G06Q 40/125; G06K 9/6254; G06Q 50/01; G06K 9/00805

(57) ABSTRACT

A contribution level determination method includes: obtaining, from a first storage device, records of annotation works for each of one or more units of target data for which the annotation works carried out by each of workers that use crowdsourcing have been completed; and calculating work contribution levels for each of worker IDs representing a different one of the workers, in accordance with a predetermined weighting rule stored in a second storage device, by referring to the records. In the calculating of the contribution levels, for each of the one or more units of target data, the work contribution level is calculated using a heavier weight for the worker ID representing a particular worker who carried out the annotation work initially than for the work contribution levels for the worker IDs representing the workers who carried out annotation works after the particular worker, in the order of the annotation works.

### CROSS REFERENCE TO RELATED APPLICATION

This application claims the benefit of priority of Japanese Patent Application Number 2018-159825 filed on Aug. 29, 2018, the entire content of which is hereby incorporated by reference.

### BACKGROUND

### 1. Technical Field

The present disclosure relates to a contribution level determination method, a contribution level determination apparatus, and a recording medium.

### 2. Description of the Related Art

In recent years, a subset of machine learning methods that is based on neural networks, namely deep learning, has been attracting attention. In a deep learning technology, learning processing is performed by using learning data in which a bounding box for indicating the position of a recognition target in an image and a correct label for indicating, for example, the type of the recognition target and the like are associated with the image, and as a result, highly accurate object recognition can be accomplished.

One method for preparing a large number of annotated images is to employ crowdsourcing. The crowdsourcing is a scheme in which works (tasks) are outsourced to many various individuals (workers) via the Internet. Using such crowdsourcing thus enables multiple workers to carry out annotation works. The annotation work is, for example, an operation in which each worker finds, in an image such as a picture frame, a particular object, such as a person, that is necessary for learning processing and attaches a bounding box indicating the area in which the object is pictured and a label indicating, for example, the type of the object, to the image targeted for recognition. In this manner, a large number of annotated images can be prepared while increase in the cost is suppressed.

For example, Japanese Unexamined Patent Application Publication No. 2017-156815 discloses a technology for determining the amount of pay with respect to individual workers in accordance with the locations at which the respective workers carried out their works and the times at which the respective workers carried out their works. With this technology, a requestor of work can maximize the volume of work to be carried out by multiple workers within a predetermined budget.

However, workers requested by using crowdsourcing to carry out works mostly work at home and at times available for the workers, and thus, it may take time until the workers start requested works and complete the works. The technology disclosed in Japanese Unexamined Patent Application Publication No. 2017-156815 described above does not provide any incentive to shorten the time taken until workers start works and the time taken until the works are completed, and as a result, it may take time until the workers start requested works and complete the works.

The present disclosure provides a contribution level determination method, a contribution level determination apparatus, and a recording medium that can encourage workers using crowdsourcing to quickly carry out works.

### SUMMARY

A contribution level determination method according to an aspect of the present disclosure is a contribution level determination method performed by a computer, and includes: obtaining, from a first storage device, records of annotation works for each of one or more units of target data for which the annotation works have been completed, the annotation works being operations for attaching annotations carried out by each of multiple workers that use crowdsourcing; and calculating work contribution levels for each of worker IDs representing a different one of the multiple workers, in accordance with a predetermined weighting rule stored in a second storage device, by referring to the records obtained in the obtaining, wherein in the calculating of the contribution levels, for each of the one or more units of target data, the work contribution level is calculated using a heavier weight for the worker ID representing a particular worker who carried out the annotation work initially in an order of the annotation works than for the work contribution levels for the worker IDs representing the workers who carried out annotation works after the particular worker in the order of the annotation works.

Note that these general or specific aspects may be implemented as a system, a method, an integrated circuit, a computer program, or a computer-readable recording medium such as a CD-ROM, or may be implemented as any combination of a system, an apparatus, a method, an integrated circuit, a computer program, and a recording medium.

The present disclosure provides a contribution level determination method, a contribution level determination apparatus, and a recording medium that can encourage workers using crowdsourcing to quickly carry out works.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 illustrates an example of an overall configuration of a system according to Embodiment 1;

FIG. 2 illustrates an example of a still image retained in a sensor data DB according to Embodiment 1;

FIG. 3 illustrates an example of an annotation work screen provided by an annotation tool according to Embodiment 1;

FIG. 4A illustrates an example of an annotation work screen provided by an annotation tool according to Embodiment 1;

FIG. 4B illustrates an example of an annotation work screen provided by an annotation tool according to Embodiment 1;

FIG. 4C illustrates an example of an annotation work screen provided by an annotation tool according to Embodiment 1;

FIG. 5 illustrates an example of annotation work data stored in an annotation work data DB according to Embodiment 1;

FIG. 6 illustrates an example of a detailed configuration of a payment amount calculator according to Embodiment 1;

FIG. 7A is a flowchart illustrating an example of operation of a contribution level determination apparatus according to Embodiment 1;

FIG. 7B is a flowchart illustrating an example of detailed operation in step S20 in FIG. 7A;

FIG. 8A illustrates another example of the annotation work screen provided by the annotation tool according to Embodiment 1;

FIG. 8B illustrates an example of the annotation work screen in the case in which the representations of annotation works are displayed on the annotation work screen illustrated in FIG. 8A;

FIG. 8C illustrates an example of the annotation work screen in the case in which the representations of annotation works are displayed on the annotation work screen illustrated in FIG. 8A;

FIG. 9 illustrates an example of an overall configuration of a system according to Embodiment 2;

FIG. 10 illustrates an example of a detailed configuration of a determiner illustrated in FIG. 9;

FIG. 11 illustrates an example of an annotation work screen provided by an annotation tool according to Embodiment 2;

FIG. 12 illustrates an example of the annotation work screen provided by the annotation tool according to Embodiment 2;

FIG. 13 is a flowchart illustrating work completion determination processing of a contribution level determination apparatus according to Embodiment 2; and

FIG. 14 is a flowchart illustrating inappropriate-work determination processing of the contribution level determination apparatus according to Embodiment 2.

### DETAILED DESCRIPTION OF THE EMBODIMENTS

A contribution level determination method according to an aspect of the present disclosure is a contribution level determination method performed by a computer, and includes: obtaining, from a first storage device, records of annotation works for each of one or more units of target data for which the annotation works have been completed, the annotation works being operations for attaching annotations carried out by each of multiple workers that use crowdsourcing; and calculating work contribution levels for each of worker IDs representing a different one of the multiple workers, in accordance with a predetermined weighting rule stored in a second storage device, by referring to the records obtained in the obtaining, wherein in the calculating of the contribution levels, for each of the one or more units of target data, the work contribution level is calculated using a heavier weight for the worker ID representing a particular worker who carried out the annotation work initially in an order of the annotation works than for the work contribution levels for the worker IDs representing the workers who carried out annotation works after the particular worker in the order of the annotation works.

This configuration can encourage workers using crowdsourcing to quickly carry out works.

Here, for example, the one or more units of target data denote one or more still images, and the annotation works include, for each of one or more target objects pictured in the one or more still images: attaching a bounding box to the target object to surround the target object; and attaching a label representing the target object to the bounding box.

Moreover, for example, the one or more still images may be captured by an in-vehicle camera installed in a vehicle or a monitoring camera placed at a given location, and the one or more target objects may include a person pictured in any of the one or more still images.

Furthermore, for example, the one or more units of target data denote one or more units of time series data, and the annotation works include: attaching one or more units of information of time periods to the one or more units of time series data, the one or more units of information of time periods being used for separating one or more states contained in the one or more units of time series data; and attaching one or more labels representing the one or more states to the one or more units of information of the time periods.

Moreover, for example, the one or more units of time series data may denote one or more units of sensor data that relate to a vehicle and are obtained by a sensor together with multiple images captured by an in-vehicle camera installed in the vehicle, and the one or more states may include at least one of driving conditions of the vehicle, driving locations of the vehicle, surrounding environments of the vehicle, and conditions of a road where the vehicle travels.

Furthermore, for example, in the calculating of the contribution levels, for each of the one or more units of target data, the work contribution level may be calculated using a heavier weight for the worker ID representing an other particular worker who carried out the annotation work finally in an order of the annotation works than for the work contribution levels for the worker IDs representing the workers who carried out annotation works after the particular worker and before the other particular worker in the order of the annotation works.

Furthermore, for example, the contribution level determination method may further include: receiving a setting of a particular payment amount for a unit of the one or more units of target data; and calculating, for each of the worker IDs, a payment amount by multiplying the work contribution level calculated for the worker ID in the calculating of the contribution levels by the particular payment amount received in the receiving.

Furthermore, for example, the contribution level determination method may further include: determining, for each of the one or more units of target data, whether the annotation works have been completed. In the determining, when it is detected that annotation works in which a degree of adjustment is smaller than a degree of adjustment of a previous annotation work in the order of the annotation works have been carried out for a unit of target data a predetermined number of times, a further annotation work for the unit of target data may be locked and it may be determined that the annotation works for the unit of target data have been completed.

Furthermore, for example, in the determining, when it is detected that a second annotation work, which is an annotation work in which a degree of adjustment is larger than a degree of adjustment of a first annotation work carried out previously in the order of the annotation works, has been carried out for a unit of target data, a notification may be transmitted to suggest checking whether the second annotation work for the unit of target data is improper.

Furthermore, for example, in the determining, in a case in which a number of times a second annotation work, which is an annotation work in which a degree of adjustment is larger than a degree of adjustment of a first annotation work carried out previously in the order of the annotation works, has been carried out for a unit of target data is obtained, the number of times regarding the unit of target data may be reported when it is determined that the annotation works for the unit of target data have been completed.

Furthermore, a contribution level determination apparatus according to an aspect of the present disclosure includes: an obtainer configured to obtain, from a first storage device, records of annotation works for each of one or more units of target data for which the annotation works have been completed, the annotation works being operations for attaching annotations carried out by each of multiple workers that use crowdsourcing; and a calculator configured to calculate work contribution levels for each of worker IDs representing a different one of the multiple workers, in accordance with a predetermined weighting rule stored in a second storage device, by referring to the records obtained by the obtainer. For each of the one or more units of target data, the calculator calculates the work contribution level using a heavier weight for the worker ID representing a particular worker who carried out the annotation work initially in an order of the annotation works than for the work contribution levels for the worker IDs representing the workers who carried out annotation works after the particular worker in the order of the annotation works.

Note that these general or specific aspects may be implemented as a system, a method, an integrated circuit, a computer program, or a computer-readable recording medium such as a CD-ROM, or may be implemented as any combination of a system, an apparatus, a method, an integrated circuit, a computer program, or a recording medium.

Hereinafter, a contribution level determination method, etc., according to an aspect of the present disclosure will be described in detail with reference to the drawings. Note that each of the following embodiments shows a specific example of the present disclosure. The numerical values, shapes, materials, structural components, the arrangement, etc., of the structural components shown in the following embodiments are mere examples, and thus are not intended to limit the present disclosure. Furthermore, among the structural components described in the following embodiments, structural components not recited in any one of the independent claims that indicate the broadest concepts are described as optional structural components. Furthermore, in all the embodiments, respective details can be combined.

### Embodiment 1

### [Overall Configuration of System]

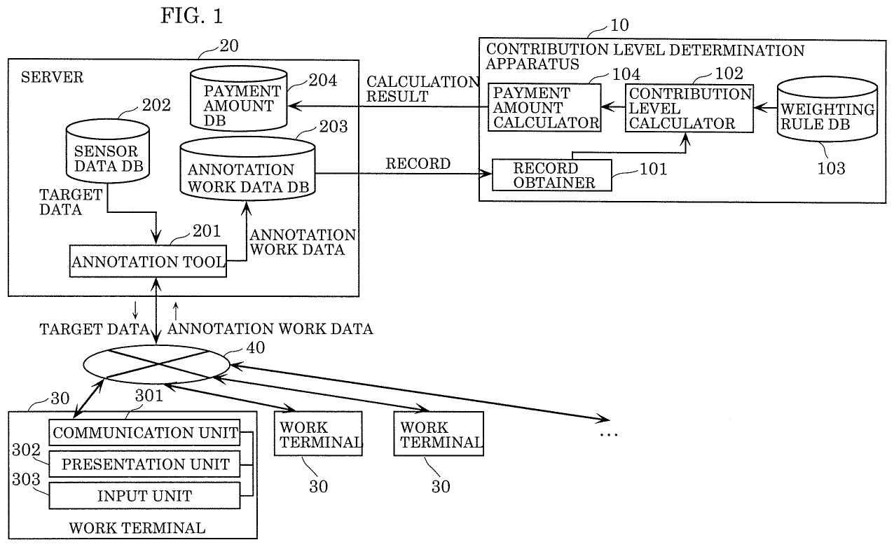

FIG. 1 illustrates an example of an overall configuration of a system according to Embodiment 1.

The system according to Embodiment 1 includes contribution level determination apparatus 10, server 20, and multiple work terminals 30 as illustrated in FIG. 1. Contribution level determination apparatus 10, server 20, and multiple work terminals 30 are connected to each other via network 40. Server 20 and contribution level determination apparatus 10 may be connected to each other via network 40 or connected directly to each other in a wired or wireless manner. The configuration of contribution level determination apparatus 10 may be partially or entirely included in server 20.

### [Configuration of Server 20]

Server 20 includes annotation tool 201, sensor data database (DB) 202, annotation work data DB 203, and payment amount DB 204. Server 20 is implemented as a computer composed of, for example, a processor (a microprocessor), a memory, and a communication interface.

### (Sensor Data DB 202)

Sensor data DB 202 is a storage device that stores target data for which multiple workers using crowdsourcing carry out annotation works. Sensor data DB 202 is implemented as, for example, a semiconductor memory and/or a hard disk. Here, the target data may be one or more still images. In this case, the one or more still images are captured by, for example, an in-vehicle camera installed in a vehicle or a monitoring camera placed at a given location.

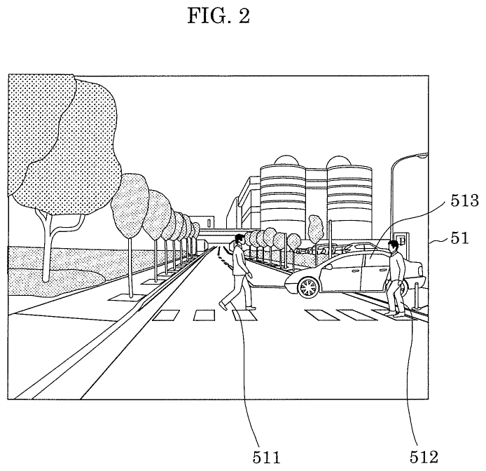

FIG. 2 illustrates an example of a still image retained in sensor data DB 202 according to Embodiment 1. Still image 51 illustrated in FIG. 2 is captured by an in-vehicle camera and pictures objects 511 and 512 each representing a person and object 513 representing an automobile.

It should be noted that the target data is not limited to one or more still images and may be one or more units of time series data. In this case, the one or more units of time series data may be each sensor data relating to a vehicle and obtained by a sensor together with a moving image or sequential still images (hereinafter referred to as a moving image) that are captured by an in-vehicle camera installed in the vehicle. Here, sensor data relating to a vehicle includes, for example, information of the speed and the acceleration of the vehicle and data based on a global positioning system (GPS) or a controller area network (CAN). Alternatively, the one or more units of time series data may be a moving image captured by a monitoring camera or sensor data obtained by vital sign sensing or environmental sensing.

### (Annotation Tool 201)

Annotation tool 201 selects, from multiple units of target data stored in sensor data DB 202, a particular unit of target data for which annotation works are to be requested and provides annotation work screens about the selected particular unit of target data for multiple work terminals 30 via network 40.

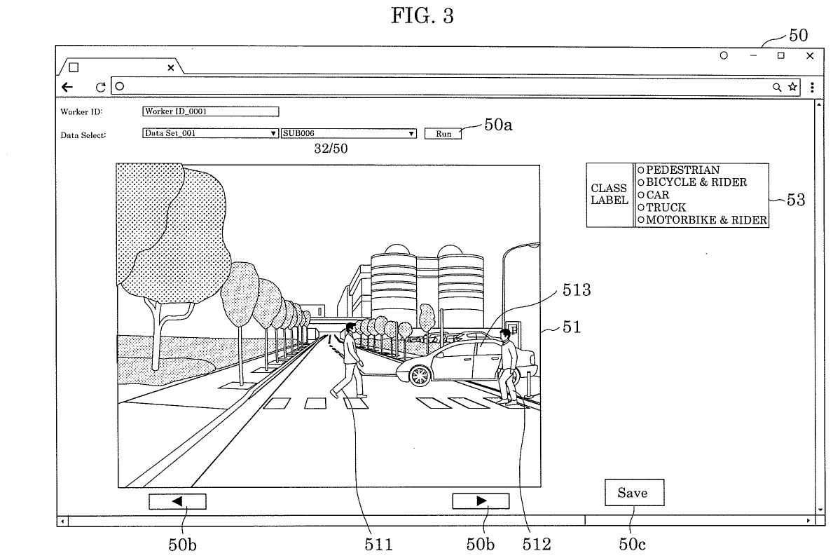

FIG. 3 illustrates an example of the annotation work screen provided by annotation tool 201 according to Embodiment 1. The same elements as those in FIG. 2 are indicated by the same reference numerals and detailed description of the elements is omitted.

Annotation work screen 50 illustrated in FIG. 3 is provided as, for example, a web page and includes RUN button 50a, data selecting areas 50b, and Save button 50c. Annotation work screen 50 also includes an image area in which still image 51 is displayed and label selection area 53. Label selection area 53 contains class labels as follows: pedestrian, bicycle & rider, car, truck, and motorbike & rider. The class label is associated with a bounding box attached for indicating the position of a target object included in still image 51 and selected from pedestrian, bicycle & rider, car, truck, and motorbike & rider. At least one worker of multiple workers for annotation works carries out an annotation work in which, for example, a worker attaches a bounding box to a target object included in still image 51 displayed on annotation work screen 50 illustrated in FIG. 3 and selects a label for the attached bounding box in label selection area 53.

The space adjacent to “Worker ID” in annotation work screen 50 is an area for inputting a worker's ID that is a unique ID for uniquely identifying a particular worker. For the purpose of avoiding another person's misuse of the ID, a password may be required to be input after the input of the ID.

The space adjacent to “Data Select” in annotation work screen 50 is an area used for selecting a data set, in which a particular data set can be selected from target data by using a pull-down menu. After a particular data set is selected, RUN button 50a is pressed and still image 51 is responsively displayed in the image area of annotation work screen 50, such that an annotation work can be started.

The configuration may be made to avoid a scenario in which a worker selects a particular data set for which an annotation work is underway by other workers. With this configuration, annotation works cannot be simultaneously carried out for the same data by multiple workers. Furthermore, the configuration may be made to not select a data set for which any annotation work is no longer necessary, such as a data set for which an annotation work has been completed. Here, when a predetermined time has elapsed after, for example, a data set became available or a first annotation work for the data set became completed, it may be assumed that annotation work for the data set has been completed. Alternatively, for example, by considering as a trigger that annotation work data relating to a data set has been changed multiple times, it may be assumed that annotation work for the data set has been completed.

By pressing data selecting areas 50b in annotation work screen 50, a particular unit of data can be selected from a selected data set (“Data_Set_001/SUB006” in the drawings) to carry out an annotation work. Data selecting areas 50b are, for example, left and right arrow buttons as illustrated in FIG. 3 and used to proceed to a subsequent unit of data or return to a preceding unit of data in regard to a unit of data for which an annotation work is to be carried out. Numerals “32/50” displayed on annotation work screen 50 denote that the selected data set contains 50 units of data and the 32nd unit of data is selected at this moment.

By pressing Save button 50c in annotation work screen 50, data content of an annotation work currently displayed on annotation work screen 50 is registered (saved) in annotation work data DB 203.

In the present embodiment, multiple workers carry out annotation works for a single unit of target data. More specifically, multiple workers using crowdsourcing carry out annotation works, which are operations for attaching annotations, for a single unit of target data; in other words, with respect to a single unit of target data for which annotation work is requested via crowdsourcing, annotation works are carried out by multiple workers who consider that they may carry out annotation works for the single unit of target data. Here, when one or more units of target data denote one or more still images, annotation works are to attach bounding boxes to individual one or more target objects pictured in the one or more still images so as to surround the individual one or more target objects and also attach labels representing the individual one or more target objects to the respective bounding boxes. The one or more target objects include a pedestrian pictured in a still image. The one or more target objects may include a vehicle. When the one or more units of target data denote one or more units of time series data, annotation works are to attach units of information of time periods for separating one or more states contained in the one or more units of time series data and also attach labels representing the individual one or more states to the one or more time periods. When the time series data denotes data obtained by an in-vehicle sensor, the one or more states include at least one of driving conditions of the vehicle, driving locations of the vehicle, surrounding environments of the vehicle, and conditions of road where the vehicle travels.

Annotation tool 201 obtains annotation work data that represents content of an annotation work carried out on the annotation work screen provided via network 40. Annotation tool 201 presents the obtained annotation work data by displaying the representation of the obtained annotation work data on the annotation work screen and stores the obtained annotation work data in annotation work data DB 203.

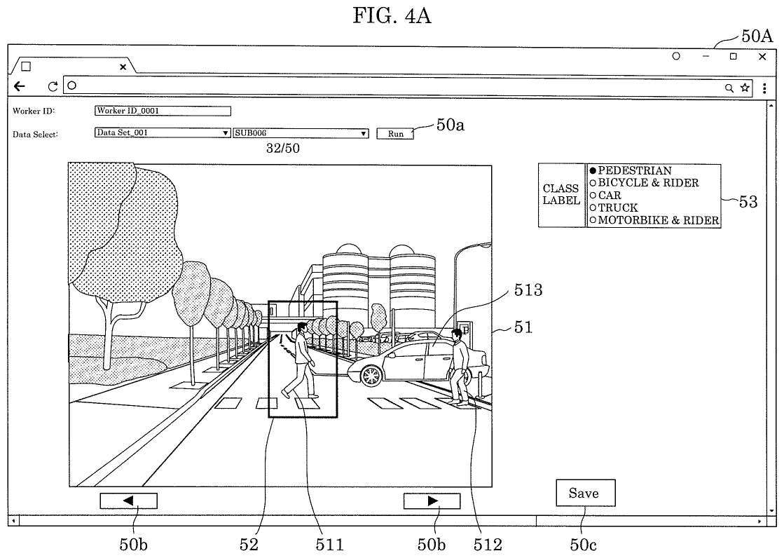

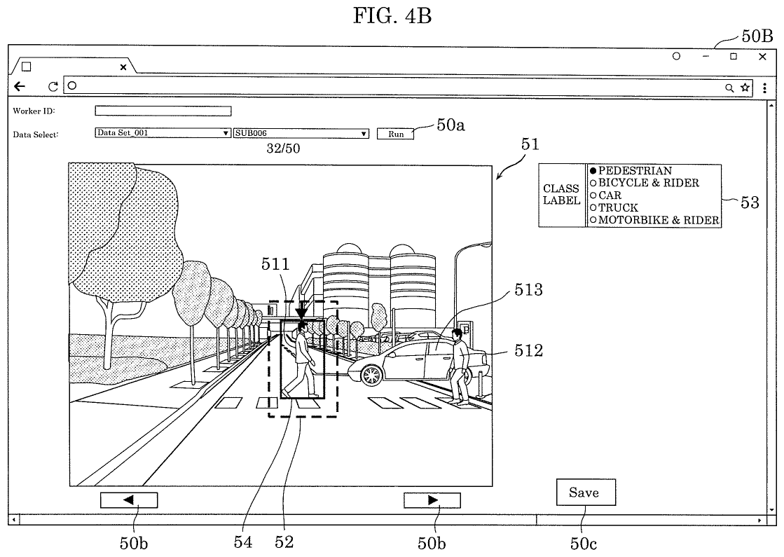

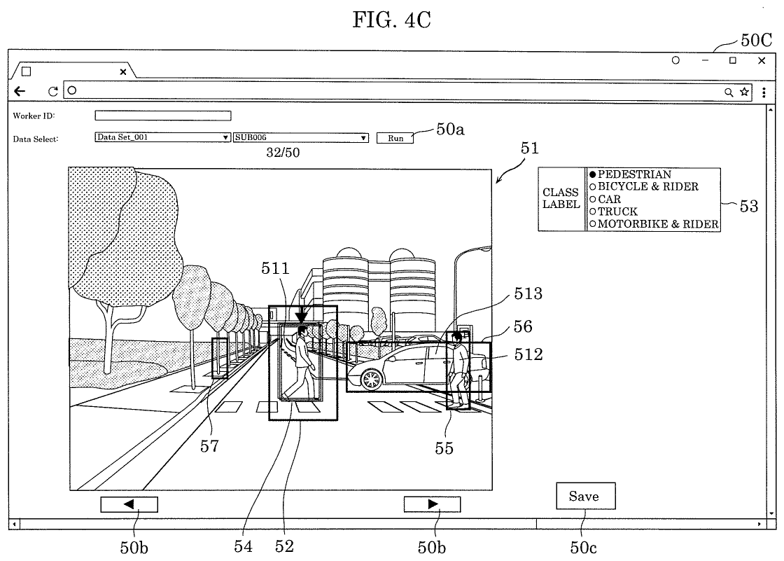

FIGS. 4A to 4C illustrate other examples of the annotation work screen provided by annotation tool 201 according to Embodiment 1. The same elements as those in FIG. 3 are indicated by the same reference numerals and detailed description of the elements is omitted.

FIG. 4A illustrates annotation work screen 50A displaying the representation of an annotation work in which bounding box 52 has been attached to object 511 contained in still image 51 and a class label of pedestrian has been selected for bounding box 52 in label selection area 53. FIG. 4B illustrates annotation work screen 50B displaying the representation of an annotation work in which bounding box 52 attached to object 511 has been changed to bounding box 54 in annotation work screen 50A. FIG. 4C illustrates annotation work screen 50C displaying the representations of multiple annotation works carried out for still image 51 included in annotation work screen 50A. More specifically, in annotation work screen 50C, bounding box 52 for object 511 in still image 51 has been changed multiple times and bounding box 55 and bounding box 56 have been newly attached respectively to object 512 and object 513. In addition, in annotation work screen 50C, bounding box 57 has been newly attached to a tree because a worker misidentified the tree as a person.

### (Annotation Work Data DB 203)

Annotation work data DB 203 is an example of a first storage device and stores records of annotation work data associated with individual units of target data. Annotation work data DB 203 is implemented as, for example, a semiconductor memory and/or a hard disk.

In the present embodiment, annotation work data DB 203 stores records of annotation work data representing annotation works carried out on the annotation work screen provided by annotation tool 201.

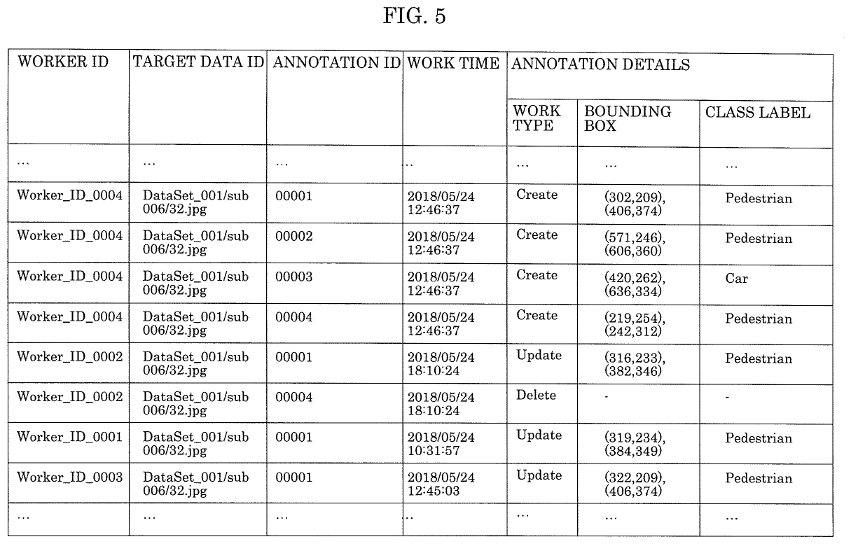

FIG. 5 illustrates an example of annotation work data stored in annotation work data DB 203 according to Embodiment 1.

As illustrated in, for example, FIG. 5, annotation work data is composed of a worker ID, a target data ID, an annotation ID, a work time, and annotation details. In the example illustrated in FIG. 5, a unit of annotation work data is structured as one row and created to correspond to an individual unit of data associated with a single still image (target data). A unit of annotation work data serves as a record of an annotation work carried out by one worker of multiple workers.

The worker ID represents a worker who has carried out a corresponding annotation work. More specifically, the worker ID is an identifier for uniquely identifying one worker of multiple workers using crowdsourcing. The example illustrated in FIG. 5 indicates multiple worker IDs of workers who have carried out annotation works for the same unit of target data. Specifically, the example illustrated in FIG. 5 indicates, as worker IDs, Worker_ID_0001, Worker_ID_0002, Worker_ID_0003, and Worker_ID_0004.

The target data ID represents a particular unit of target data for which a corresponding annotation work has been carried out. More specifically, the target data ID is an identifier for uniquely identifying a particular unit of target data for which annotation work has been requested by using crowdsourcing and for which a corresponding annotation work has been carried out. The example illustrated in FIG. 5 indicates, as a target data ID, DataSet_001/sub006/32.jpg that represents a particular unit of target data for which corresponding annotation works have been carried out.

The annotation ID represents a particular annotation attached to a unit of target data indicated by a corresponding target data ID. More specifically, the annotation ID is an identifier for uniquely identifying a particular annotation attached to a corresponding unit of target data for which annotation work has been requested by using crowdsourcing. The example illustrated in FIG. 5 indicates annotation IDs such as 00001, 00002, 00003, and 00004, each of which represents a particular bounding box or a particular time period attached to a corresponding unit of target data indicated by a target data ID. It should be noted that in the example illustrated in FIG. 5 an annotation ID is considered to be unique in relation to a target data ID, but this configuration should not be construed in a limiting sense.

The work time denotes a time when an annotation work has been carried out. More specifically, the work time denotes a time when an annotation work for a particular unit of target data identified by a target data ID indicated in the same row, such as 2018/06/24 12:46:37, is carried out. The example illustrated in FIG. 5 indicates 2018/06/24 12:46:37, 2018/06/24 18:10:24, 2018/06/25 10:31:57, and 2018/06/25 12:45:03 and the order of works can be understood from these work times.

The annotation details denote details of an annotation indicated by an annotation ID. More specifically, the annotation details denote details of an annotation indicated by a particular annotation ID in the same row.

In the example illustrated in FIG. 5, rows associated with “Create” indicate that initial annotation works have been carried out for a particular unit of target data indicated by a target data ID “DataSet_001/SUB006/32.jpg” and annotation IDs “00001” to “00004” have been associated with annotations of the annotation works. When this example is applied to FIG. 4C, the annotation ID “00001” corresponds to bounding box 52 and the annotation ID “00002” corresponds to bounding box 55. The annotation ID “00003” corresponds to bounding box 56 and the annotation ID “00004” corresponds to bounding box 57. In addition, numerals “(302, 209), (406, 374)” in a field of bounding box indicate that, concerning bounding box 52 corresponding to the annotation ID “00001”, coordinates of the upper left corner are (302, 209) and coordinates of the lower right corner are (406, 374). It should be noted that these coordinates are determined on the basis that the upper left corner of still image 51 is determined as the origin (0, 0). In addition, numerals “(571, 246), (606, 360)” in the field of bounding box indicate that, concerning bounding box 55 corresponding to the annotation ID “00002”, coordinates of the upper left corner are (571, 246) and coordinates of the lower right corner are (606, 360). Numerals “(420, 262), (636, 334)” in the field of bounding box indicate that, concerning bounding box 56 corresponding to the annotation ID “00003”, coordinates of the upper left corner are (420, 262) and coordinates of the lower right corner are (636, 334). Numerals “(219, 254), (242, 312)” in the field of bounding box indicate that, concerning bounding box 57 corresponding to the annotation ID “00004”, coordinates of the upper left corner are (219, 254) and coordinates of the lower right corner are (242, 312).

Moreover, a class label “Pedestrian” in FIG. 5 indicates that a pedestrian is selected and a class label “CAR” indicates that a car is selected. When this example is applied to FIG. 4C, object 511 to which bounding box 52 indicated by the annotation ID “00001” is attached is a pedestrian. Object 512 to which bounding box 55 indicated by the annotation ID “00002” is attached is also a pedestrian. Object 513 to which bounding box 56 indicated by the annotation ID “00003” is attached is a car. In addition, an object to which bounding box 57 indicated by the annotation ID “00004” is attached is actually a tree but mistakenly indicated as a pedestrian.

“Update” indicated in FIG. 5 denotes that an annotation work for updating an annotation attached to, for example, an object contained in a unit of target data represented by the target data ID “DataSet_001/sub006/32.jpg” has been carried out. FIG. 5 indicates that workers represented by Worker_ID_0002, Worker_ID_0001, and Worker_ID_0003, sequentially in this order, have changed bounding box 52 indicated by the annotation ID “00001” to reduce the size of bounding box 52. In the example illustrated in FIG. 5, the upper left corner and the lower right corner of the bounding box indicated by the annotation ID “00001” have been changed from the positions indicated by coordinates of “(302, 202), (406, 374)” to the positions indicated by coordinates of “(316, 233), (382, 346)”, and then to the positions “(322, 209), (406, 374)”. The corresponding class label remains to be a pedestrian that has been selected and not changed.

Furthermore, “Delete” indicated in FIG. 5 denotes that an annotation work for deleting an annotation attached to, for example, an object contained in a unit of target data represented by the target data ID “DataSet_001/sub006/32.jpg” has been carried out. FIG. 5 indicates that an adjustment for deleting bounding box 57, which is represented by the annotation ID “00004” and was mistakenly attached by Worker_ID_0004, has been made. When this example is applied to FIG. 4C, bounding box 57 represented by the annotation ID “00004” has been deleted from still image 51 because bounding box 57 was mistakenly attached.

### (Payment Amount DB 204)

Payment amount DB 204 is a storage device that stores a calculation result output by contribution level determination apparatus 10. Payment amount DB 204 is implemented as, for example, a semiconductor memory and/or a hard disk.

In the present embodiment, payment amount DB 204 stores, with respect to each worker, information of the amount of payment that is the remuneration for the entire volume of one or more units of target data and the amount of payment is calculated by using contribution levels of the particular worker calculated with respect to respective units of target data. The contribution level is normalized such that the total of contribution levels of all workers for one unit of target data is 1. With this configuration, a requestor using crowdsourcing can make payments for workers in accordance with the payment amount for each worker recorded in payment amount DB 204.

### [Configuration of Work Terminals 30]

Work terminal 30 includes, as illustrated in FIG. 1, communication unit 301, presentation unit 302, and input unit 303. Work terminal 30 is implemented as a computer composed of, for example, a processor (a microprocessor), a memory, a sensor, and a communication interface. Work terminal 30 is a personal computer or a portable terminal, such as a tablet computer.

### (Communication Unit 301)

Communication unit 301 is implemented as, for example, a processor and a communication I/F and communicates with server 20. More specifically, communication unit 301 transmits to presentation unit 302 data of the annotation work screen regarding target data provided by server 20.

Communication unit 301 also transmits to server 20 annotation work data representing an annotation work that has been input via input unit 303 and has been carried out on the annotation work screen.

### (Presentation Unit 302)

Presentation unit 302 presents the annotation work screen regarding target data transmitted by server 20 via communication unit 301. Presentation unit 302 presents, for example, annotation work screen 50 illustrated in FIG. 3.

Presentation unit 302 also presents the annotation work screen displaying the representation of an annotation work for target data transmitted via communication unit 301. For example, presentation unit 302 presents annotation work screen 50A displaying the representation of an annotation work for target data as illustrated in FIG. 4A or annotation work screen 50B displaying the representation of an annotation work for target data as illustrated in FIG. 4B.

### (Input Unit 303)

Input unit 303 is an interface device that receives inputs from a user. When target data contained in the annotation work screen presented by presentation unit 302 represents an image, input unit 303 receives input operations of an annotation work, such as attaching a bounding box to a target object contained in the target data, updating a bounding box, or deleting a bounding box. For example, using as an example annotation work screen 50A illustrated in FIG. 4A, input unit 303 may receive inputs corresponding to operations of an annotation work such as attaching to object 511 bounding box 52 for indicating the position of object 511 and selecting a class label in label selection area 53.

When target data contained in the annotation work screen presented by presentation unit 302 is time series data, input unit 303 may receive an input operations of an annotation work, such as attaching information of a time period corresponding to a state contained in target data, updating information of a time period, or deleting information of a time period.

### [Contribution Level Determination Apparatus 10]

Contribution level determination apparatus 10 includes record obtainer 101, contribution level calculator 102, weighting rule DB 103, and payment amount calculator 104. Contribution level determination apparatus 10 is implemented as a computer composed of, for example, a processor (a microprocessor), a memory, a sensor, and a communication interface.

### (Record Obtainer 101)

Record obtainer 101 obtains from annotation work data DB 203 records of annotation works that are operations for attaching annotations and that have been carried out with respect to one or more units of target data by multiple workers using crowdsourcing.

For example, record obtainer 101 obtains multiple units of annotation work data illustrated in FIG. 5 from annotation work data DB 203.

Record obtainer 101 may assume that particular annotation works corresponding to particular records among multiple records of annotation work data stored in annotation work data DB 203 have been completed and then obtain the particular records. The particular records are selected when a predetermined time has elapsed since a work time that is associated with new creation in annotation details and that corresponds to the particular records. This is because it can be assumed that all annotation works have been completed when a predetermined time has elapsed since the work time associated with new creation in annotation details, the work time being a time when an initial annotation work is carried out for a corresponding unit of target data.

### (Contribution Level Calculator 102)

Contribution level calculator 102 refers to the records obtained by record obtainer 101 and calculates work contribution levels for respective workers IDs indicating multiple workers in accordance with a predetermined weighting rule stored in weighting rule DB 103. Contribution level calculator 102 calculates, with respect to individual one or more units of target data, a work contribution level for a worker ID representing a particular worker who has carried out an annotation work initially in the order of works to be a highly weighted level compared to work contribution levels for worker IDs representing workers who have carried out annotation works after the particular worker in the order of works.

When time is used as a trigger for determining the completion of annotation work, the number of workers who carry out the annotation works is unpredictable, and thus, for example, a ratio of contribution level between a new-creation worker and an adjustment worker may be recorded in weighting rule DB 103. With this configuration, contribution levels can be calculated for any number of adjustment workers.

When the number of times an annotation work of adjustment is carried out is used as a trigger for determining the completion of annotation work, since the number of workers is accordingly determined, for example, a contribution level for a new-creation worker and a contribution level for an adjustment worker may be directly recorded in weighting rule DB 103.

With this configuration, among multiple workers assigned to a unit of target data, a worker who has initially carried out an annotation work, such as attaching a bounding box, can obtain more payment compared to others, and thus, this configuration encourages workers to quickly carry out their works. As a result, the time taken until an annotation work is completed can be reduced. In addition, the total time of provision of the annotation work screen performed by server 20 can be reduced, resulting in saving energy.

Furthermore, contribution level calculator 102 may determine, with respect to the individual one or more units of target data, a work contribution level for a worker ID representing another particular worker who has carried out an annotation work finally in the order of works to be a highly weighted level compared to work contribution levels for worker IDs representing workers who have carried out annotation works between the particular worker and the other particular worker in the order of works.

With this configuration, among multiple workers assigned to a unit of target data, a worker who has finally carried out an annotation work of adjustment, such as adjusting the area of a bounding box, can obtain more payment compared to others. This enables placing a value on the adjustment of annotation carried out by the same or another worker, and thus, this configuration can not only encourage an adjusting work for a unit of target data but also reduce the time taken until the completion of annotation work. As a result, the total time of provision of the annotation work screen performed by server 20 can be reduced, resulting in saving energy.

### (Weighting Rule DB 103)

Weighting rule DB 103 is an example of a second storage device and implemented as, for example, a semiconductor memory and/or a hard disk. Weighting rule DB 103 stores a predetermined weighting rule.

In the present embodiment, a weighting rule for weighting by the highest weight a particular worker who has carried out an annotation work initially in the order of works as described above is recorded in weighting rule DB 103. Additionally, another weighting rule for weighting by the second highest weight another particular worker who has carried out an annotation work finally in the order of works is recorded in weighting rule DB 103.

### (Payment Amount Calculator 104)

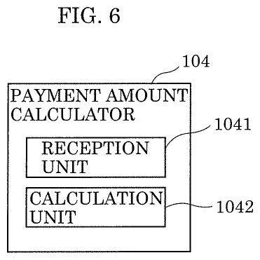

FIG. 6 illustrates an example of a detailed configuration of payment amount calculator 104 according to Embodiment 1.

Payment amount calculator 104 includes reception unit 1041 and calculation unit 1042 and calculates, with respect to each worker, a payment amount for the entire volume of one or more units of target data.

Reception unit 1041 receives a setting of a payment amount for a single unit of target data.

Here, since the number of one or more still images or one or more states included in a single unit of target data is uncertain, if a requestor pays a given amount of payment in accordance with the number, the given amount of payment may exceed the budget of the requestor. In consideration of this case, in the present embodiment, a payment amount is determined with respect to a single unit of target data, and thus, the increase in the amount of payment that a requestor needs to pay can be suppressed.

Calculation unit 1042 calculates, with respect to each worker ID, a payment amount by multiplying a work contribution level calculated for the particular worker ID by contribution level calculator 102 by the particular payment amount received by reception unit 1041.

With this configuration, when a worker initially carries out an annotation work for target data, the amount of payment paid to the worker increases; or when a worker finally carries out an annotation work for target data, the amount of payment paid to the worker increases. This configuration provides workers with incentive for quickly starting or completing annotation works for target data.

### [Operation of Contribution Level Determination Apparatus 10]

Next, operation of contribution level determination apparatus 10 configured as described above is described.

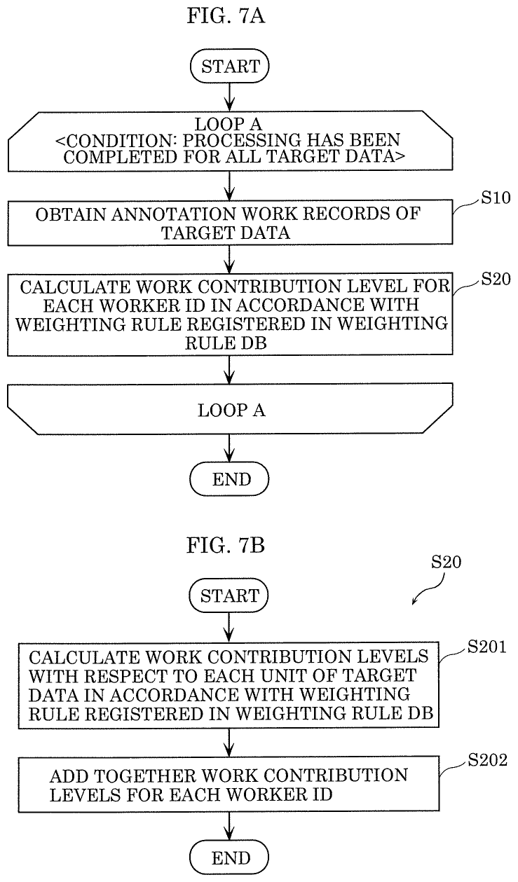

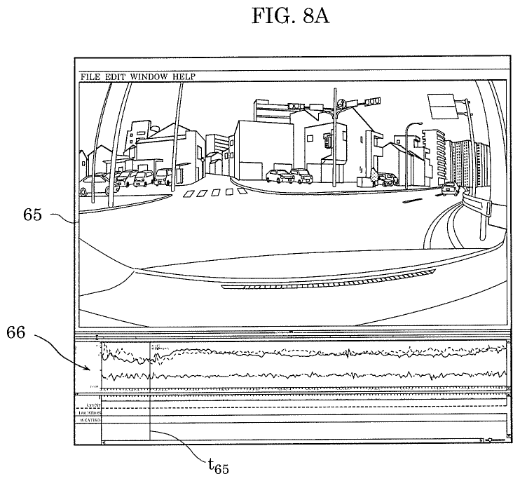

FIG. 7A is a flowchart illustrating an example of operation of contribution level determination apparatus 10 according to Embodiment 1. FIG. 7B is a flowchart illustrating an example of detailed operation in step S20 in FIG. 7A.

Firstly, contribution level determination apparatus 10 obtains annotation work records for target data (S10). More specifically, contribution level determination apparatus 10 selects a unit of target data from target data for which annotation work has been completed and obtains all annotation work records relating to the selected unit of target data. Here, when it is described by using FIG. 5, in the case in which the selected target data is DataSet_001/sub006/32.jpg, contribution level determination apparatus 10 obtains from annotation work data DB 203 all work records in which DataSet_001/sub006/32.jpg is recorded in the field of target data ID.

Subsequently, contribution level determination apparatus 10 calculates a work contribution level with respect to each worker ID in accordance with the weighting rule registered in weighting rule DB 103 (S20). More specifically, as illustrated in FIG. 7B, contribution level determination apparatus 10 refers to the records obtained in step S10 and accordingly calculates work contribution levels with respect to each unit of target data on the basis of the weighting rule registered in weighting rule DB 103 (S201). Next, contribution level determination apparatus 10 adds together work contribution levels for each worker ID (S202), such that a work contribution level of each worker ID is calculated.

When processing, that it, calculation of work contribution level for all units of target data has not been completed after step S20, the process returns to step S10 and work contribution levels for another unit of target data are calculated. Conversely, when processing for all units of target data has been completed, contribution level determination apparatus 10 ends the operation.

### [Advantageous Effects, Etc.]

As described above, the present embodiment provides a contribution level determination method and the like that can encourage workers requested to work by using crowdsourcing to quickly carry out works.

More specifically, among multiple workers assigned to a unit of target data, a worker who has initially carried out an annotation work, such as attaching a bounding box, can obtain more payment compared to others, and thus, this configuration encourages workers to quickly carry out their works. As a result, the time taken until an annotation work is completed can be reduced. The total time of provision of the annotation work screen performed by server 20 can be reduced accordingly, resulting in saving energy.

Furthermore, among multiple workers assigned to a unit of target data, a worker who has finally carried out an annotation work of adjustment, such as adjusting the area of a bounding box, can obtain more payment compared to others. When, a payment amount is determined with respect to each unit of target data, the amounts of payment distributed to respective workers may be determined in accordance with a ratio of contribution level with respect to the particular unit of target data. These enables placing a value on the adjustment of annotation carried out by the same or another worker, and thus, this configuration can not only encourage an adjusting work for a unit of target data but also reduce the time taken until the completion of annotation work. Moreover, the total time of provision of the annotation work screen performed by server 20 can be reduced, resulting in saving energy.

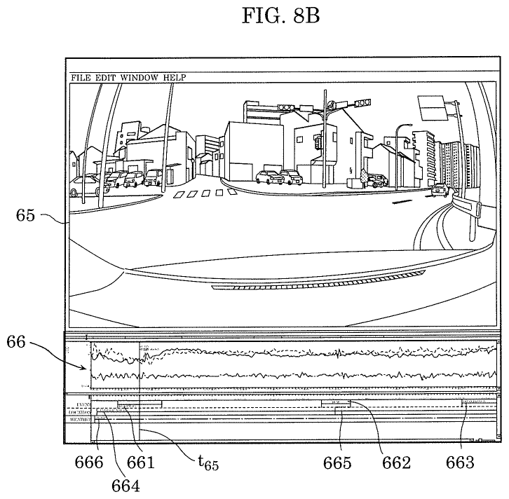

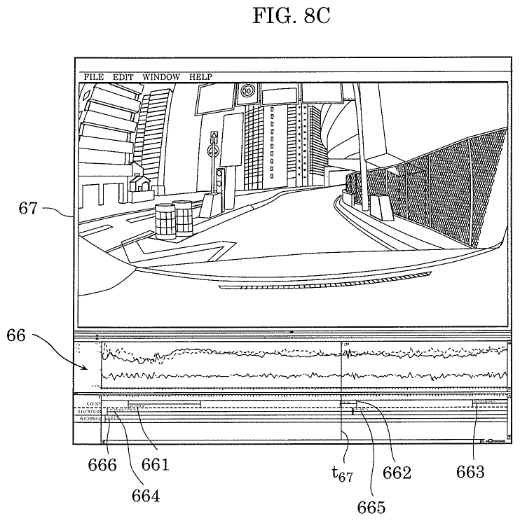

It should be noted that the above description of this embodiment is about an example of annotation work in the case of using images captured by an in-vehicle camera as target data, such as attaching a bounding box to object 511 representing a person, with reference to FIGS. 3, 4A, and 4B, but the application of this embodiment is not limited to this example. Hereinafter, another example of annotation work in the case of using time series data as target data is described with reference to FIGS. 8A, 8B, and 8C.

FIG. 8A illustrates another example of the annotation work screen provided by annotation tool 201 according to Embodiment 1. An annotation work screen illustrated in FIG. 8A is provided as a web page and contains a representation of time series data 66 and image 65 captured at time t₆₅. Time series data 66 is sensor data including information of acceleration of a vehicle and represented in FIG. 8A as a graph illustrating, for example, rates of acceleration corresponding respectively to x, y, and z directions (horizontal, lateral, and vertical directions) with respect to a vehicle, in chronological order. In addition, images captured by an in-vehicle camera installed in the vehicle are associated with respective time points in time series data 66. Image 65 is captured at time t₆₅ by the in-vehicle camera.

As described above, annotation tool 201 may provide an annotation work screen containing a representation of time series data 66 and image 65 captured at time t₆₅.

FIGS. 8B and 8C illustrate examples of the annotation work screen in the case in which the representations of annotation works are displayed on the annotation work screen illustrated in FIG. 8A. The same elements as those in FIG. 8A are indicated by the same reference numerals and detailed description of the elements is omitted.

In the annotation work screen illustrated in FIG. 8B, multiple units of information of multiple time periods used for separating multiple states have been attached as annotations by multiple workers and labels representing the corresponding states have been attached to the multiple units of information of the multiple time periods. Specifically, at least one worker checks the changes in acceleration in time series data 66 and image 65 and the like associated with the respective time points and attaches information about, for example, events of the vehicle, locations, and weather as annotations. In the example illustrated in FIG. 8B, information of time period 661 in which vehicle turns right, information of time period 662a in which the vehicle passes over a bump, and information of time period 663 in which the vehicle decelerates have been attached as events, and additionally, labels representing vehicle's driving conditions, such as turning right, passing over a bump, and decelerating, and labels representing conditions of road where the vehicle travels have been attached.

Furthermore, in the example illustrated in FIG. 8B, information of time period 664 in which the vehicle travels along a general roadway and information of time period 665 in which a vehicle travels along a highway have been attached as locations, and additionally, labels representing vehicle's driving locations, such as a general roadway and a highway, have been attached.

Moreover, in the example illustrated in FIG. 8B, information of time period 666 for which it is cloudy has been attached as weather and a label representing vehicle's surrounding environment, such as cloudy weather, has been attached.

The annotation work screen illustrated in FIG. 8C contains a representation of time series data 66 and image 67 captured at time t₆₇. As illustrated in the annotation work screen in FIG. 8C, image 67 captured at time t₆₇ is, for example, an image at the time of determination that the vehicle passes through a bump in accordance with the change in acceleration at time t₆₇ in time series data 66. Other details described above are omitted from the description here.

### Embodiment 2

In the description of Embodiment 1, the completion of annotation work is determined when a given time has elapsed since a work time at which a crowdsourcing worker initially carried out an annotation work. However, when annotation works of only slight adjustments are successively carried out for a bounding box attached to a unit of target data, it may be assumed that annotation work has been completed. In the description of Embodiment 1, crowdsourcing multiple workers properly carry out annotation work. However, multiple workers may include a malicious person having harmful intentions. In this case, it is expected that the malicious person may attempt to increase the number of times an annotation work of adjustment is carried out or attempt to become an initial worker or a final worker of annotation works by changing the size of a bounding box attached to a unit of target data or deleting the bounding box.

The present embodiment describes a contribution level determination apparatus or the like that can determine the completion of annotation work and determine the possibility of annotation work carried out by a malicious person, focusing especially on configurations different from Embodiment 1.

### [Overall Configuration of System]

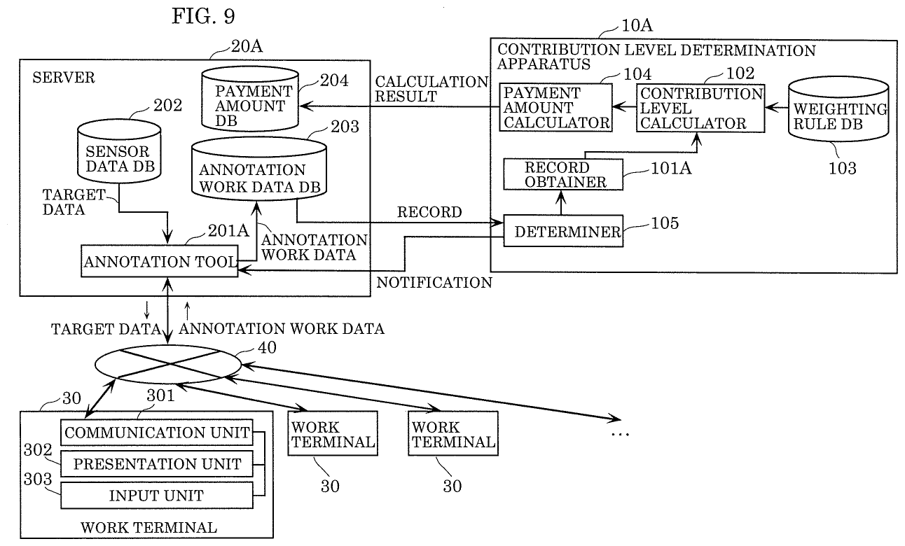

FIG. 9 illustrates an example of an overall configuration of a system according to Embodiment 2. The same elements as those in FIG. 1 are indicated by the same reference numerals and detailed description of the elements is omitted.

The system according to Embodiment 2 differs from the system according to Embodiment 1 in the configuration of server 20A and the configuration of contribution level determination apparatus 10A. Other configurations are the same as those of the system according to Embodiment 1 and the description of the other configurations is omitted.

### [Configuration of Server 20A]

Server 20A includes annotation tool 201A, sensor data DB 202, annotation work data DB 203, and payment amount DB 204. Server 20A is also implemented as a computer composed of, for example, a processor (a microprocessor), a memory, a sensor, and a communication interface.

Server 20A differs from server 20 illustrated in FIG. 1 in the configuration of annotation tool 201A.

### (Annotation Tool 201A)

Annotation tool 201A selects, from multiple units of target data stored in sensor data DB 202, a particular unit of target data for which annotation works are to be requested and provides annotation work screens about the selected particular unit of target data for multiple work terminals 30 via network 40.

Annotation tool 201A obtains annotation work data that is produced by an annotation work carried out on the annotation work screen provided via network 40. Annotation tool 201A presents the obtained annotation work data by displaying the representation of the obtained annotation work data on the annotation work screen and stores the obtained annotation work data in annotation work data DB 203.

In the present embodiment, when receiving a notification of a need for locking the annotation work from contribution level determination apparatus 10A, annotation tool 201A locks a further annotation work for a particular unit of target data to not accept annotation work. In other words, when receiving a notification of a need for locking the annotation work, annotation tool 201A may lock the annotation work by stopping obtaining annotation work data and stopping accepting a further annotation work. Alternatively, when receiving a notification of a need for locking the annotation work, annotation tool 201A may lock the provided annotation work screen, display a notification for not accepting a further input. Annotation tool 201A stops obtaining further annotation work data for the annotation work screen.

### [Contribution Level Determination Apparatus 10A]

Contribution level determination apparatus 10A includes record obtainer 101A, contribution level calculator 102, weighting rule DB 103, payment amount calculator 104, and determiner 105. Contribution level determination apparatus 10A is implemented as a computer composed of, for example, a processor (a microprocessor), a memory, a sensor, and a communication interface.

Contribution level determination apparatus 10A differs from contribution level determination apparatus 10 illustrated in FIG. 1 in the configuration of record obtainer 101A, and more specifically, determiner 105 is added in contribution level determination apparatus 10A.

### (Determiner 105)

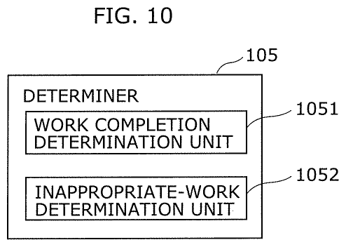

FIG. 10 illustrates an example of a detailed configuration of determiner 105 illustrated in FIG. 9.

Determiner 105 includes work completion determination unit 1051 and inappropriate-work determination unit 1052.

Work completion determination unit 1051 determines, with respect to individual one or more units of target data, whether annotation work has been completed. More specifically, when work completion determination unit 1051 detects that annotation works in which the degree of adjustment is smaller than the degree of adjustment of the previous annotation work in the order of works have been carried out for a unit of target data the predetermined number of times, a further annotation work for the unit of target data is locked and it is determined that annotation work for the unit of target data has been completed. Here, the condition in which annotation works of the particular type are performed the predetermined number of times may denote, for example, a condition in which annotation works of the particular type are successively performed twice or more or a condition in which an annotation work of the particular type is performed once.

Work completion determination unit 1051 may determine that annotation work has been completed when detecting that any adjusting work for target data has not been carried out for a predetermined time.

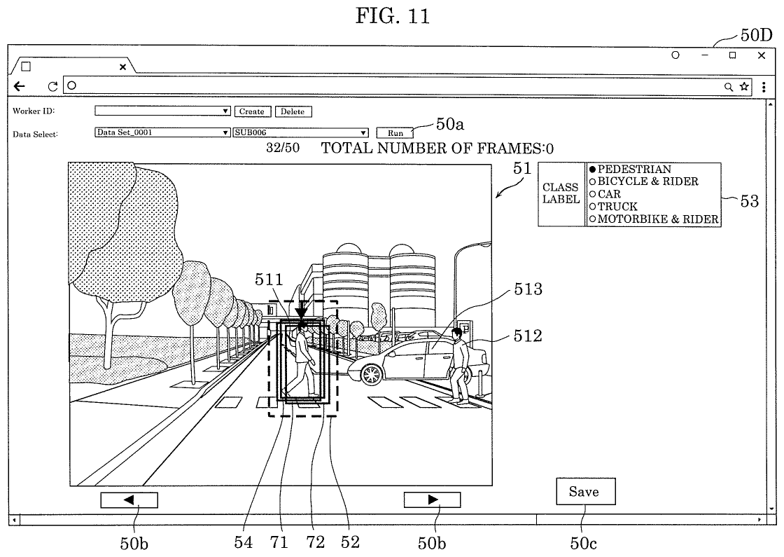

FIG. 11 illustrates an example of the annotation work screen provided by annotation tool 201A according to Embodiment 2. The same elements as those in FIG. 4B and the other drawings are indicated by the same reference numerals and detailed description of the elements is omitted.

FIG. 11 illustrates annotation work screen 50D displaying representations of multiple units of annotation work data. More specifically, FIG. 11 indicates that bounding box 52 attached to object 511 in still image 51 was changed to bounding box 54, bounding box 54 was changed again to bounding box 71, and bounding box 71 was then changed again to bounding box 72. It can be seen from FIG. 11 that the adjustments of bounding box 54 and subsequent bounding boxes were all slight adjustments and it can be assumed that the annotation works such as attaching bounding box 54 to object 511 have been completed.

In other words, with regard to annotation work data stored in annotation work data DB 203, among the multiple units of annotation work data whose representations are illustrated in FIG. 11, the position of bounding box 54, the position of bounding box 71, the position of bounding box 72 were only slightly changed from coordinates that correspond to a preceding location of the bounding box and are indicated in the annotation details. In this regard, in the present embodiment, work completion determination unit 1051 firstly obtains records of annotation works corresponding to a unit of target data from annotation work data DB 203. Next, work completion determination unit 1051 calculates whether two or more successive annotation works have been carried out for the unit of target data in such a manner that the degree of adjustment of the particular annotation work is smaller than the degree of adjustment of the previous annotation work in the order of works. When determining by the calculation that two or more successive annotation works have been carried out for the unit of target data in such a manner, work completion determination unit 1051 notifies annotation tool 201 included in server 20 of a need for locking a further annotation work for the unit of target data. Upon transmitting this notification, work completion determination unit 1051 determines that annotation work for the unit of target data has been completed.

When inappropriate-work determination unit 1052 detects that a second annotation work has been carried out for a unit of target data, the second annotation work being an annotation work in which the degree of adjustment is larger than that of a first annotation work that has been carried out previously in the order of the annotation works, a notification is transmitted to suggest checking whether the second annotation work for the unit of target data is improper.

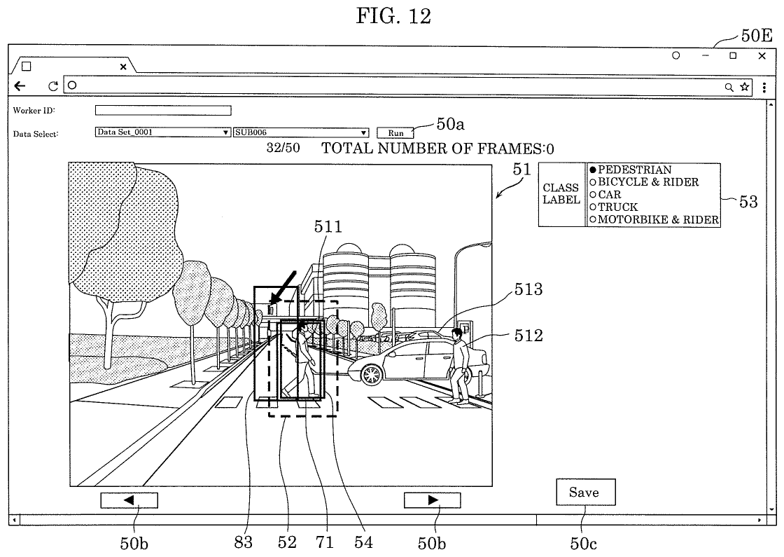

FIG. 12 illustrates an example of annotation work screen 50E provided by annotation tool 201A according to Embodiment 2. The same elements as those in FIG. 4B and the other drawings are indicated by the same reference numerals and detailed description of the elements is omitted.

FIG. 12 illustrates annotation work screen 50E displaying representations of multiple units of annotation work data. More specifically, FIG. 12 indicates that bounding box 52 attached to object 511 in still image 51 was changed to bounding box 54, bounding box 54 was changed to bounding box 71, and bounding box 71 was then changed again to bounding box 83. It can be seen from FIG. 12 that the degree of adjustment from bounding box 54 to bounding box 71 is relatively slight, whereas the degree of adjustment from bounding box 71 to bounding box 83 is increased relative to the previous adjustment and bounding box 83 is inappropriate as a bounding box attached to object 511, compared to bounding box 71. It cannot be determined whether the adjustment from bounding box 71 to bounding box 83 has been made due to a worker's mistake or a malicious annotation work for increasing the number of annotation works, and thus, a requestor or an administrator of server 20 needs to check whether the adjustment is malicious.

Concerning annotation work data stored in annotation work data DB 203, among the multiple units of annotation work data whose representations are illustrated in illustrated in FIG. 12, it is seen from the coordinates of bounding box 71 and the coordinates of bounding box 83 that the degree of adjustment with respect to the position of the bounding box is relatively large. In this regard, in the present embodiment, inappropriate-work determination unit 1052 firstly obtains records of annotation works corresponding to a unit of target data from annotation work data DB 203. Next, inappropriate-work determination unit 1052 calculates whether an annotation work has been carried out for the unit of target data in such a manner that the degree of adjustment of the particular annotation work is larger than that of the previous annotation work in the order of works. When determining by the calculation that an annotation work has been carried out for the unit of target data in such a manner, inappropriate-work determination unit 1052 may transmit to annotation tool 201 included in server 20 a notification for suggesting checking whether the annotation work is improper, such that an administrator of server 20 or the like is notified to perform a checking operation. Alternatively, inappropriate-work determination unit 1052 may transmit directly to the administrator a notification for suggesting checking whether the annotation work is improper.

Inappropriate-work determination unit 1052 may calculate the number of times the second annotation work has been carried out for the unit of target data, in which the degree of adjustment of the second annotation work is larger than that of the first annotation work performed previously in the order of works. In this case, when work completion determination unit 1051 determines that annotation work for a unit of target data has been completed, inappropriate-work determination unit 1052 may report the number of times the second annotation work has been carried out for the unit of target data. Inappropriate-work determination unit 1052 may report the number of times to, for example, an administrator of server 20 by notifying annotation tool 201 included in server 20 of the number of times or report directly to the administrator.

### (Record Obtainer 101A)

Record obtainer 101A obtains from annotation work data DB 203 records of annotation works that have been carried out with respect to one or more units of target data by multiple workers using crowdsourcing.

In the present embodiment, when work completion determination unit 1051 determines that annotation work for one or more units of target data has been completed, record obtainer 101A obtains from annotation work data DB 203 records of annotation works with respect to the individual one or more units of target data for which it is determined that annotation work has been completed. Other configurations are the same as those in Embodiment 1 and the description of the other configuration is thus omitted.

### [Operation of Contribution Level Determination Apparatus 10A]

Next, determination operation of contribution level determination apparatus 10A configured as described above is described.

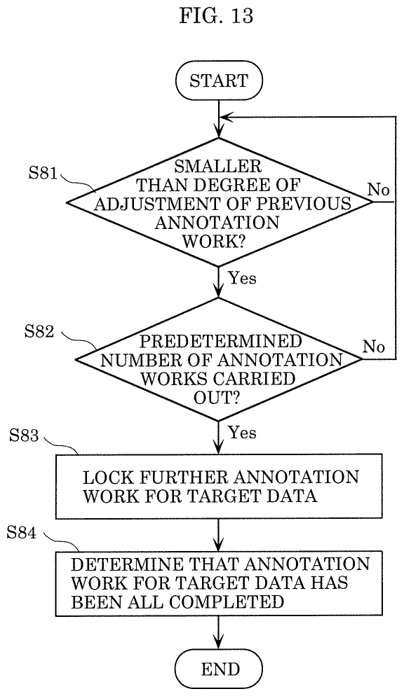

FIG. 13 is a flowchart illustrating work completion determination processing of contribution level determination apparatus 10A according to Embodiment 2.

Firstly, contribution level determination apparatus 10A determines whether the degree of adjustment of a particular annotation work is smaller than that of the previous annotation work (S81). Contribution level determination apparatus 10A may determine whether the degree of adjustment of a particular annotation work is smaller than that of the previous annotation work by performing calculation in accordance with the coordinates of annotation details contained in annotation work data stored in annotation work data DB 203.

In step S81, when determining that the degree of adjustment of a particular annotation work is smaller than that of the previous annotation work (Yes in S81), contribution level determination apparatus 10A then determines whether two or more annotation works of such a kind have been successively carried out. Conversely, when determining that the degree of adjustment of a particular annotation work is not smaller than that of the previous annotation work (No in S81), the processing in step S81 is repeated again.

In step S82, when determining that two or more annotation works of such a kind have been successively carried out (Yes in S82), contribution level determination apparatus 10A locks a further annotation work for the target data (S83). More specifically, contribution level determination apparatus 10A transmits to annotation tool 201 included in server 20 a notification for locking a further annotation work for the unit of target data. In this manner, annotation tool 201 of server 20 is caused to lock a further annotation work for the unit of target data.

Next, contribution level determination apparatus 10A determines that annotation work for the target data has been completed (S84). More specifically, when the annotation work for the unit of target data is locked by annotation tool 201 of server 20, contribution level determination apparatus 10A determines that annotation work for the unit of target data has been completed.

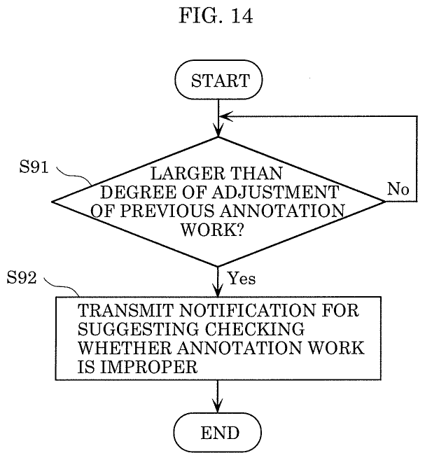

FIG. 14 is a flowchart illustrating inappropriate-work determination processing of contribution level determination apparatus 10A according to Embodiment 2.

Firstly, contribution level determination apparatus 10A determines whether the degree of adjustment of a particular annotation work is larger than that of the previous annotation work (S91). Contribution level determination apparatus 10A may determine whether the degree of adjustment of a particular annotation work is larger than that of the previous annotation work by performing calculation in accordance with, for example, the coordinates of annotation details contained in annotation work data stored in annotation work data DB 203.

In step S91, when determining that the degree of adjustment of a particular annotation work is larger than that of the previous annotation work (Yes in S91), contribution level determination apparatus 10A transmits a notification for suggesting checking whether the particular annotation work is improper (S92). More specifically, contribution level determination apparatus 10A may transmit to annotation tool 201 included in server 20 a notification for suggesting checking whether the annotation work is improper, such that an administrator of server 20 or the like is notified and suggested to perform a checking operation. It should be noted that contribution level determination apparatus 10A may transmit directly to the administrator a notification for suggesting checking whether the annotation work is improper.

### [Advantageous Effects, Etc.]

As described above, in the present embodiment, an administrator or the like is suggested to check whether a particular annotation work is a malicious annotation work that is carried out intentionally by a worker who is requested to work by using crowdsourcing. This configuration enables detecting and managing a malicious worker.

Furthermore, in the present embodiment, it is determined whether annotation work has been completed, in accordance with the degrees of adjustment of annotation work carried out by workers requested by using crowdsourcing. This configuration enables automatic determination of the completion of annotation work.

### Possibility for Other Embodiments

Although the contribution level determination method according to one or more aspects of the present disclosure has been described above on the basis of the embodiments, the present disclosure is not limited to such embodiments. The one or more aspects may thus include forms obtained by making various modifications to the above embodiments that can be conceived by those skilled in the art, as well as forms obtained by combining structural components in different embodiments, without materially departing from the spirit of the present disclosure. For example, the present disclosure includes the cases described below.

(1) More specifically, each of the devices in Embodiments above may be a computer system configured with, for example, a microprocessor, a ROM, a RAM, a hard disk unit, a display unit, a keyboard, and a mouse. The RAM or the hard disk unit stores a computer program. The microprocessor operates according to the computer program, so that each function of the devices is achieved. Here, the computer program includes a plurality of instruction codes indicating instructions to be given to the computer so as to achieve a specific function.
(2) Some or all of the structural components included in each of the devices above may be realized as a single system large scale integration (LSI). The system LSI is a super multifunctional LSI manufactured by integrating a plurality of structural components onto a signal chip. To be more specific, the system LSI is a computer system configured with a microprocessor, a ROM, and a RAM, for example. The RAM stores a computer program. The microprocessor operates according to the computer program, so that a function of the system LSI is achieved.
(3) Some or all of the structural components included in each of the devices described above may be implemented as an IC card or a standalone module that can be inserted into and removed from the corresponding device. The IC card or the module is a computer system configured with a microprocessor, a ROM, and a RAM, for example. The IC card or the module may include the aforementioned super multifunctional LSI. The microprocessor operates according to the computer program, so that a function of the IC card or the module is achieved. The IC card or the module may be tamper-resistant.
(4) The present disclosure may be the methods described above. Each of the methods may be a computer program causing a computer to execute the steps included in the method. Moreover, the present disclosure may be a digital signal of the computer program.
(5) Moreover, the present disclosure may be the aforementioned computer program or digital signal recorded on a computer-readable recording medium, such as a flexible disk, a hard disk, a CD-ROM, an MO, a DVD, a DVD-ROM, a DVD-RAM, a Blu-ray (registered trademark) disc (BD), or a semiconductor memory. The present disclosure may also be the digital signal recorded on such a recording medium.
(6) Furthermore, the present disclosure may be the aforementioned computer program or digital signal transmitted via a telecommunication line, a wireless or wired communication line, a network represented by the Internet, and data broadcasting.
(7) Moreover, the present disclosure may be a computer system including a microprocessor and a memory. The memory may store the aforementioned computer program and the microprocessor may operate according to the computer program.
(8) Furthermore, by transferring the recording medium having the aforementioned program or digital signal recorded thereon or by transferring the aforementioned program or digital signal via the aforementioned network or the like, the present disclosure may be implemented by a different independent computer system.

### INDUSTRIAL APPLICABILITY

The present disclosure is applied to a contribution level determination method, a contribution level determination apparatus, and a program. In particular, the present disclosure is applied to, for example, a server and a system that are used when annotation work is distributed to crowdsourcing workers.

What is claimed is:

1. A contribution level determination method performed by a computer, comprising:
obtaining, from a first storage device, records of annotation works for each of one or more units of target data for which the annotation works have been completed, the annotation works being operations for attaching annotations carried out by each of multiple workers that use crowdsourcing; and
calculating work contribution levels for each of worker IDs representing a different one of the multiple workers, in accordance with a predetermined weighting rule stored in a second storage device, by referring to the records obtained in the obtaining, wherein
in the calculating of the contribution levels, for each of the one or more units of target data, the work contribution level is calculated using a heavier weight for the worker ID representing a particular worker who carried out the annotation work initially in an order of the annotation works than for the work contribution levels for the worker IDs representing the workers who carried out annotation works after the particular worker in the order of the annotation works.

2. The contribution level determination method according to claim 1, wherein
the one or more units of target data denote one or more still images, and
the annotation works include, for each of one or more target objects pictured in the one or more still images:
attaching a bounding box to the target object to surround the target object; and
attaching a label representing the target object to the bounding box.

3. The contribution level determination method according to claim 2, wherein
the one or more still images are captured by an in-vehicle camera installed in a vehicle or a monitoring camera placed at a given location, and
the one or more target objects include a person pictured in any of the one or more still images.

4. The contribution level determination method according to claim 1, wherein
the one or more units of target data denote one or more units of time series data, and
the annotation works include:
attaching one or more units of information of time periods to the one or more units of time series data, the one or more units of information of time periods being used for separating one or more states contained in the one or more units of time series data; and
attaching one or more labels representing the one or more states to the one or more units of information of the time periods.

5. The contribution level determination method according to claim 4, wherein
the one or more units of time series data denote one or more units of sensor data that relate to a vehicle and are obtained by a sensor together with multiple images captured by an in-vehicle camera installed in the vehicle, and
the one or more states include at least one of driving conditions of the vehicle, driving locations of the vehicle, surrounding environments of the vehicle, and conditions of a road where the vehicle travels.

6. The contribution level determination method according to claim 2, wherein
in the calculating of the contribution levels, for each of the one or more units of target data, the work contribution level is calculated using a heavier weight for the worker ID representing an other particular worker who carried out the annotation work finally in an order of the annotation works than for the work contribution levels for the worker IDs representing the workers who carried out annotation works after the particular worker and before the other particular worker in the order of the annotation works.

7. The contribution level determination method according to claim 2, further comprising:
receiving a setting of a particular payment amount for a unit of the one or more units of target data; and
calculating, for each of the worker IDs, a payment amount by multiplying the work contribution level calculated for the worker ID in the calculating of the contribution levels by the particular payment amount received in the receiving.

8. The contribution level determination method according to claim 1, further comprising:
determining, for each of the one or more units of target data, whether the annotation works have been completed, wherein
in the determining, when it is detected that annotation works in which a degree of adjustment is smaller than a degree of adjustment of a previous annotation work in the order of the annotation works have been carried out for a unit of target data a predetermined number of times, a further annotation work for the unit of target data is locked and it is determined that the annotation works for the unit of target data have been completed.

9. The contribution level determination method according to claim 8, wherein
in the determining, when it is detected that a second annotation work, which is an annotation work in which a degree of adjustment is larger than a degree of adjustment of a first annotation work carried out previously in the order of the annotation works, has been carried out for a unit of target data, a notification is transmitted to suggest checking whether the second annotation work for the unit of target data is improper.

10. The contribution level determination method according to claim 8, wherein
in the determining, in a case in which a number of times a second annotation work, which is an annotation work in which a degree of adjustment is larger than a degree of adjustment of a first annotation work carried out previously in the order of the annotation works, has been carried out for a unit of target data is obtained, the number of times regarding the unit of target data is reported when it is determined that the annotation works for the unit of target data have been completed.

11. A contribution level determination apparatus, comprising:
an obtainer configured to obtain, from a first storage device, records of annotation works for each of one or more units of target data for which the annotation works have been completed, the annotation works being operations for attaching annotations carried out by each of multiple workers that use crowdsourcing; and
a calculator configured to calculate work contribution levels for each of worker IDs representing a different one of the multiple workers, in accordance with a predetermined weighting rule stored in a second storage device, by referring to the records obtained by the obtainer, wherein
for each of the one or more units of target data, the calculator calculates the work contribution level using a heavier weight for the worker ID representing a particular worker who carried out the annotation work initially in an order of the annotation works than for the work contribution levels for the worker IDs representing the workers who carried out annotation works after the particular worker in the order of the annotation works.

12. A non-transitory computer-readable recording medium that stores a program which causes a computer to execute:
obtaining, from a first storage device, records of annotation works for each of one or more units of target data for which the annotation works have been completed, the annotation works being operations for attaching annotations carried out by each of multiple workers that use crowdsourcing; and
calculating work contribution levels for each of worker IDs representing a different one of the multiple workers, in accordance with a predetermined weighting rule stored in a second storage device, by referring to the records obtained in the obtaining, wherein
in the calculating of the contribution levels, for each of the one or more units of target data, the work contribution level is calculated using a heavier weight for the worker ID representing a particular worker who carried out the annotation work initially in an order of the annotation works than for the work contribution levels for the worker IDs representing the workers who carried out annotation works after the particular worker in the order of the annotation works.
